(19) United States
(12) Patent Application Publication
(10) Pub. No.: US 2006/0271474 A1
(43) Pub. Date: Nov. 30, 2006

(54) System and method for enhancing real estate transactions

(76) Inventor: Ronald Bruce Patterson, Alexandria, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/135,447

(22) Filed: May 24, 2005

(51) Int. Cl. G06Q 40/00

(52) U.S. Cl. 705/39

(57) ABSTRACT

A computer aided system and method run by a transaction service firm enrolls participating real estate agents in its database. The participating agents which are accepted for enrollment agree to rebate a certain portion of their listing or selling commission to the seller or buyer, respectively. The firm advertises its discount services to the public, and a potential seller or buyer may register for a fee with the firm. Once registered, the seller or buyer is matched with a participating agent who may accept a listing or sale, which is handled in the normal manner within the brokerage firm for which the agent works. At closing, or other agreed time, the listing and/or selling agent would then rebate a portion of his commission to the client.

### BACKGROUND OF THE INVENTION

1. Field of the Invention

The present invention generally relates to a system and method for enhancing real estate transactions and, more particularly, to a computer aided system and method which provides a central database for matching clients and registered agents wherein clients are provided with rebates or discounts of real estate commissions and registered agents, in turn, are provided with access to increased numbers of listings and purchasers.

2. Background Description

Traditionally, real estate brokers and agents work on commission. A real estate broker operates a brokerage for the buying and selling of real estate. The term real estate broker may refer to a business entity, or to an individual licensed to run or work with such a business. While an individual real estate agent or broker is a realtor who assists sellers in selling their property or buyers in purchasing property, the term real estate agent typically refers to an individual who works for a real estate broker. In most states, both individual real estate brokers and real estate agents are licensed, but since a real estate agent is not licensed to run a brokerage business, the real estate agent's license is held by the broker for which he or she may work.

Real estate listing agreements between brokers and sellers specify a sales commission fee in terms of a percentage of the final selling price of the property. This fee, when collected at the completion of the conveyancing of the property, is split between brokers and agents according to a predetermined arrangement. A typical arrangement might be a sales commission of six percent (6%). The listing agent and listing agent's broker receive half of the commission, and the selling agent and selling agent's broker receive the other half of the commission. The split between agent and broker varies within each company. For newly licensed agents, the split might again be half and half; that is, the broker receiving 1½% and the agent receiving 1½%. On the other hand, more experienced and productive agents generally receive a more favorable split, sometimes as high as the full 3%, less monthly expenses. Those experienced in the real estate industry understand that the key to increased commissions, for both agent and broker, is increasing the number of listings and sales. Sales depend on listings, and even if the listing agent is not the selling agent, the listing agent receives some predetermined share of the total commission.

Increasingly there is pressure to increase competition among real estate brokerage firms. Part of this pressure is brought by the Antitrust Division of the U.S. Department of Justice. The real estate establishment has been warned not to block efforts to save consumers money through rebates of real estate commissions and not to stand in the way of discount “fee-for-service” firms that will list seller's properties for a fixed-dollar amount but not perform all the traditional brokerage services. Brokerage firms have resisted such changes, and since real estate agents are themselves not licensed to operate brokerage firms but must work for a broker, real estate agents are generally not in a position to offer more competitive deals than their broker will allow.

### SUMMARY OF THE INVENTION

It is therefore an object of the present invention to provide a computer aided system and method which will enable individual agents to participate in competitive rebates of real estate commissions to consumers, both sellers and buyers, without affecting the division of fees between the agent and his or her broker.

According to the invention, there is provided a computer aided system and method run by a “fee-for-service” firm, herein referred to as a transaction service, which enrolls participating real estate agents in its database. The participating agents which are accepted for enrollment agree to rebate a certain portion of their listing or selling commission to the seller or buyer, respectively. The firm advertises its discount services to the public, and a potential seller and/or purchaser may register for a fee with the firm. Once registered, the client is matched with a participating agent who may accept the listing or the purchasing requirement, which is handled in the normal manner within the brokerage firm for which the agent works. At closing, or other agreed time, the listing and/or selling agent would then rebate a portion of his or her commission to the client.

The invention provides several important advantages to the several participants in the transaction. For the seller, there is the advantage of a reduced commission as a result of the rebate while at the same time receiving full service, just as today. For the listing agent, there is the advantage of an increased number of listings without having to do the work that ordinarily would be involved in obtaining those listings. For the purchaser, there is the advantage of receiving full service plus a substantial commission rebate. For the selling agent, there is the advantage of obtaining a referral of a likely purchaser for a listed property. For the transaction service firm, there is the advantage of attracting potential sellers, and their fees, without having to offer traditional brokerage services, such as advertising and holding open houses. Note that there is no direct impact on the brokerage firms or non-participating listing and selling agents. They continue to collect the full amount of their fees, as in a normal transaction. Potentially, there is an indirect, and favorable, advantage to the listing broker because of the increase in number of listings of an agent or agents working for the broker and, similarly, there is the potential advantage to the selling broker because of the increase in number of sales of an agent or agents working for the broker. Because the transaction service firm presence will not be indicated in any transaction, either by name or disclosure in the open market, sellers and buyers will not be subject to sale price pressure, as they are now when they are seen as “not paying a commission”.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing a portion of the process of on-line registering of a potential seller and/or buyer with the transaction service firm;

FIG. 2 is a flow diagram which, when taken with FIG. 1, shows the completing of the registration process and the matching of the client with an agent from the firm's data base;

FIG. 3 is a flow diagram, similar to FIG. 1, but showing the registration process by telephone;

FIGS. 4 and 5, taken together, constitute a flow diagram showing the process by which an agent is registered and added to the firm's database;

FIG. 6 is a flow diagram showing a subroutine of the overall process of FIG. 2 wherein an agent from one of the firm's databases is matched with a client; and

FIG. 7 is a pictorial block diagram illustrating a network used for implementing the processes according to the present invention.

### DETAILED DESCRIPTION OF A PREFERRED EMBODIMENT OF THE INVENTION

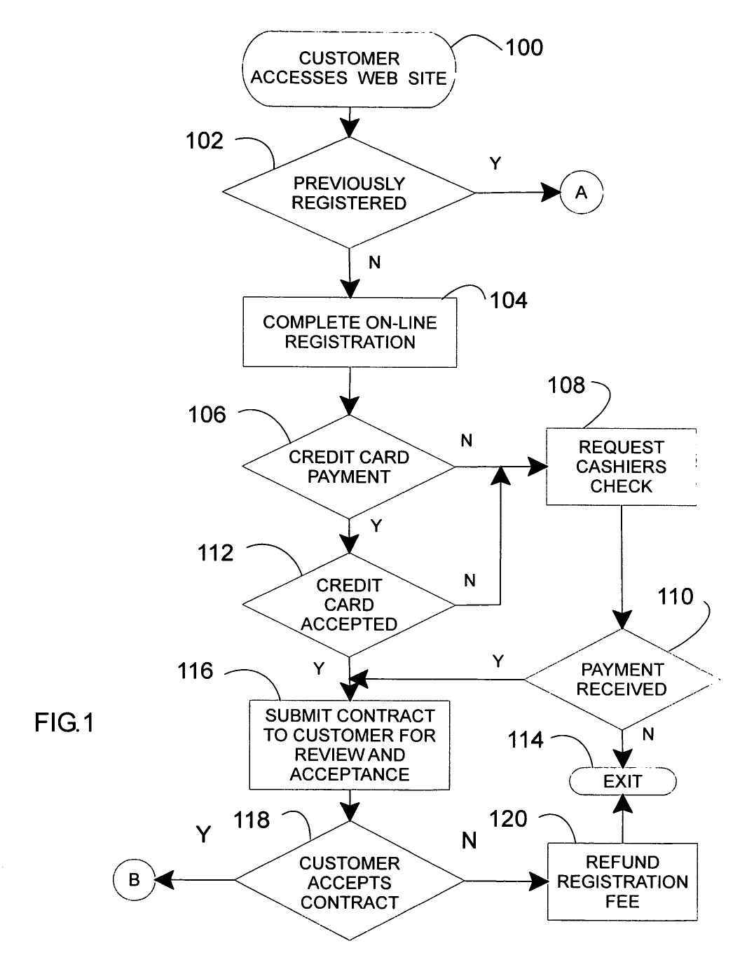

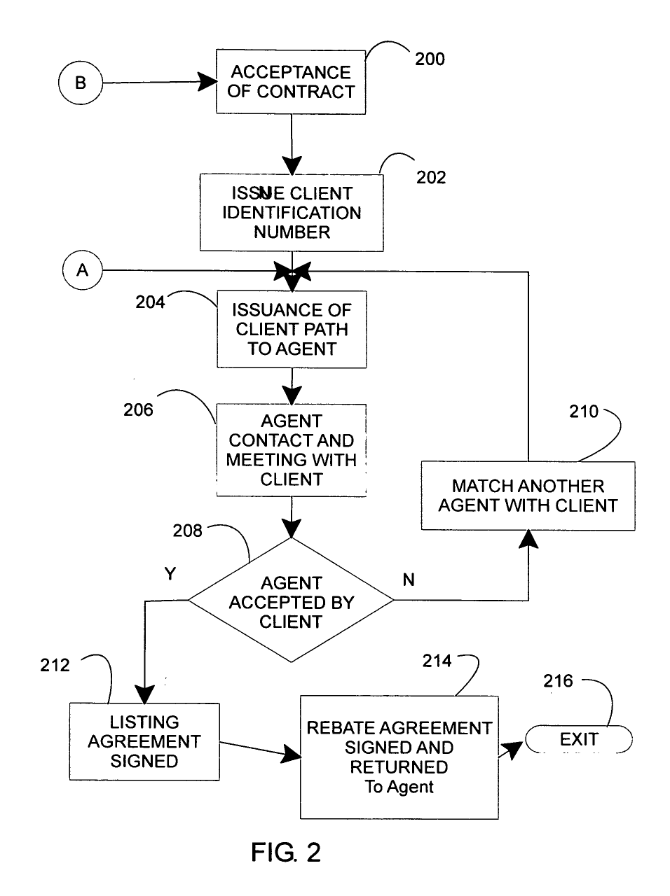

Referring now to the drawings, and more particularly to FIG. 1, there is shown a flow diagram wherein, in response to the transaction service firm's advertisements, other customer's referrals or the like, a potential customer (i.e., a seller or buyer) accesses the firm's Web site at input block 100. Upon accessing the Web site the potential customer is queried at decision block 102 as to whether he or she was previously registered. If so, the process exits via connector “A” to FIG. 2, which is discussed in more detail hereinafter. Assuming that the potential customer is not currently registered, he or she is asked to select whether they are a potential seller or buyer of real estate. Once this selection has been made, the potential customer is presented with an on-line registration form in function block 104. The on-line registration form, in the case of a seller, seeks to elicit from the potential customer such information as name(s) of owner(s) of the property to be sold, the address and/or the zip code of the property, and asking price range. In the case of a buyer, corresponding information is sought, that is, location, price range and features of property desired. Registration preferably requires payment of a fee, and the potential customer is asked his or her preferred method of payment, one method being by credit card. A determination is made in decision block 106 as to whether credit card payment has been elected. If not, the potential customer is instructed in function block 108 to submit a cashiers check or other secure payment to the firm either by mail, courier or secure electronic transfer of funds. The process is suspended until payment is received as determined in decision block 110. If credit card payment is elected, a determination is made in decision block 112 if the credit card is accepted by the issuing bank. If not, the process goes to function block 108. Again, the process is suspended until payment is received as determined in decision block 110. Decision block 110 may include a time-out function such that after a predetermined period of time and no payment has been received, the process exits at block 114. Once payment is received or the potential customer's credit card has been accepted, the firm's contract is submitted to the potential customer for review and acceptance in function block 116. This contract sets forth the services provided by the firm, and those services which are not provided, for the fixed fee registration.

Among those services provided is the matching of potential customer with a licensed real estate agent who has agreed in advance to rebate at least a predetermined portion of the agent's listing or selling commission upon completion of the sale or purchase of the property. The potential customer, after having reviewed the contract, either accepts or refuses the contract. If the potential customer refuses the contract, as determined in decision block 118, the registration fee is refunded in full in function block 120, and the process exits at block 114. If, on the other hand, the potential customer accepts the contract as determined in decision block 118, the process goes, via connector “B” to FIG. 2, at which point the potential customer becomes a client of the firm.

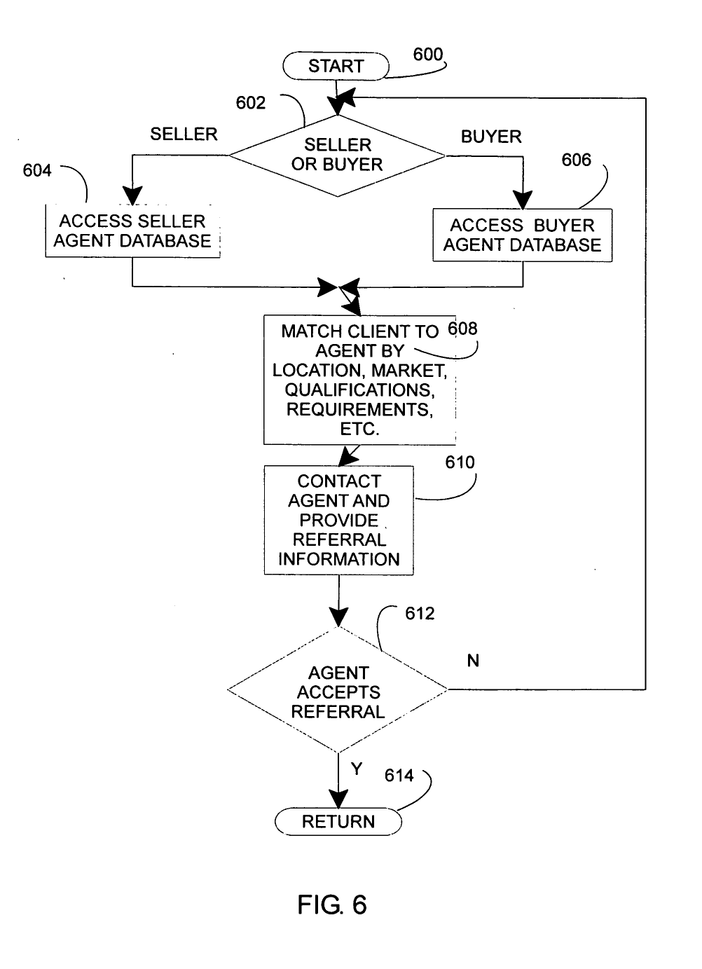

Referring now to FIG. 2, the firm's contract is entered as accepted by the client in function block 200. The client is issued an identification number in function block 202 and the client information, as entered in the registration process, is entered in the firm's database. At this point in the process, the firm issues a client path to an agent from its database of agents in function block 204. This is also the point in the process where connector “A” from FIG. 1 enters the process. The process by which an agent in the database is matched with the client is described in more detail with reference to FIG. 6, described herein below. An agent who has been matched with the client contacts the client within 24 hours or one business day. Upon contacting the client, the agent arranges a meeting with the client in function block 206. The client may, for whatever reason, prefer not to work with this particular agent. If, as determined in decision block 208, the client does not accept the agent initially matched to the client or if the registered agent does not accept the client, the firm accesses its database of agents in function block 210 to match another agent with the client, and the process returns to function block 204. To prevent this part of the process from becoming an endless loop, the firm's contract may provide a limited number of rejections, say two, by a client, and if no agent within that number of matches is found acceptable, the firm, at its option, may refund a portion of the registration fee and remove the client from its database. Once the agent is accepted by the client, as determined in decision block 208, the agent submits the listing agreement for his or her broker to be signed by the client in function block 212 and, as part of the same transaction, the rebate agreement between the agent and the client is signed and a copy returned to the agent in function block 214. At this point the listing process is complete and the process exits at block 216.

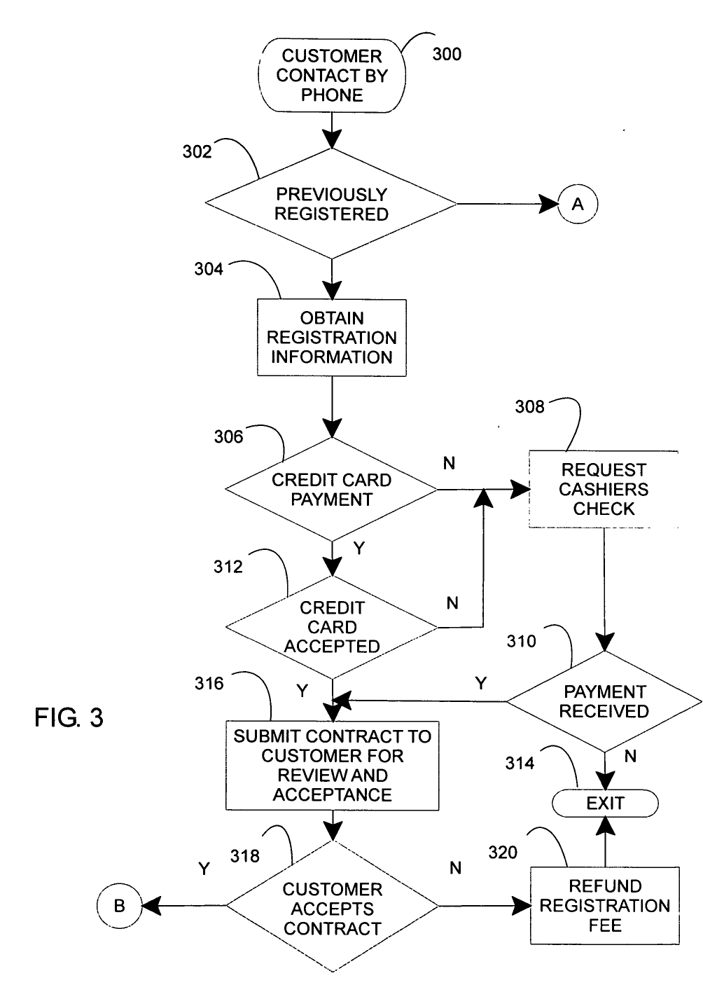

FIG. 3 is similar to FIG. 1, but contemplates the situation where the contact of the potential customer with the firm is by telephone at input block 300. The person receiving the telephone call first determines in decision block 302 whether the potential customer is previously registered and, if so, the process goes via connector “A” to FIG. 2, as previously described. If not previously registered, the person receiving the telephone call obtains the necessary registration information and enters it into the firm's database in function block 304. The payment process is essentially the same as that described with respect to FIG. 1 except that it is handled by telephone rather than on-line. Thus, the potential customer will be asked whether they prefer to pay by credit card, decision block 306, or other method, function block 308. If the latter is elected, or if the credit card is not accepted, decision block 312, the process is suspended until payment is received, decision block 310. Once payment is received, the firm's contract is submitted to the potential customer in function block 316. Since this process is being conducted in part by telephone, the customer is asked whether he or she has a facsimile machine to which the contract may be transmitted. If not, the contract is mailed or sent by courier to the potential customer for review. The potential customer is asked to note his or her acceptance of the contract by signing and dating the contract and returning the contract either by facsimile, mail, courier or other agreed manner. If the customer does not accept the contract as determined in decision block 318, the registration fee is refunded in full in function block 320 and the process exits at block 314. Rejection of the contract can be determined in any of a number of commercially recognized ways, including a verbal rejection by telephone or return of the contract marked “rejected”. In addition, the decision block 318 may have a time-out function associated with it such that if the contract has not been accepted by a predetermined time, the contract is rejected.

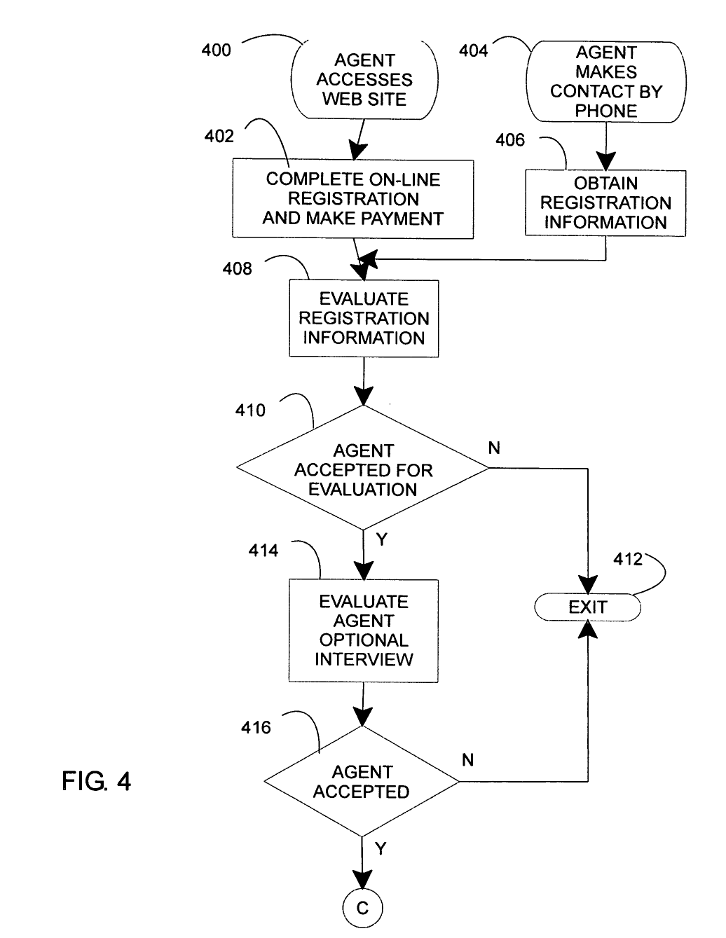

FIG. 4 shows the process by which agents apply to be listed in the firm's database of agents. An agent may access the firm's Web site at input block 400. The agent will be presented with an on-line registration form in function block 402. This form elicits such information as the agent's name, location, licensing jurisdiction(s), brokerage firm, level of experience (e.g., number of years in the business, brokerage firms worked for, awards, etc.), sales volume over, say, the past three years, language skills, support staff, and other skills and assets. As part of the registration process, the agent preferably will be required to pay a registration fee, which preferably will not be refundable should the agent not be accepted for the firm's database, and if accepted, the agent preferably will be required to pay an annual renewal fee to be maintained in the firm's database. As part of the renewal process (not shown), the agent's performance may be reviewed to determine whether the agent will be maintained in the firm's database. The agent may, alternatively, contact the firm by telephone at input block 404. In this case, the person at the firm receiving the phone call obtains the necessary information in function block 406. Note that the agent as part of the registration process may be given the opportunity to specify whether he or she is willing to make rebates on listing contracts, selling contracts or both. It is contemplated that, in many cases, a client may be both seller and buyer, so it is possible that an agent, if registered to provide rebates on both listing contracts and selling contracts, would receive a referral to such a client.

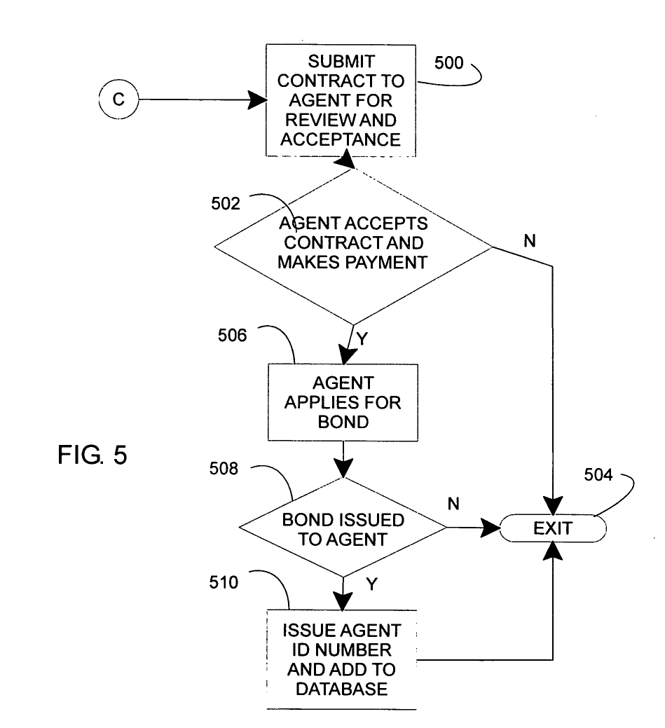

Once the agent information is complete, there is an initial evaluation of the registration information in function block 408. This may be done by computer matching of predetermined criteria. A determination is made in decision block 410 as to whether the agent is accepted for evaluation. If not, the process exits at block 412. The agent may also be notified that he or she has not been accepted for evaluation, and reasons for the non-acceptance may be given. Assuming that the agent is accepted for evaluation, this is done at function block 414 which may include an optional interview with the agent. A determination is made in decision block 416 as to whether the agent is accepted. If not, the process exits at block 412; otherwise, the process goes, via connector “C”, to FIG. 5, to which attention is now directed.

From connector “C” in FIG. 5, the process enters function block 500. Here, the firm's contract is submitted to the agent for review and acceptance. The firm's contract includes clauses whereby the agent agrees to rebate a predetermined portion of his or her listing and/or selling commissions to a firm client referred to the agent by the firm. Further, the firm's contract includes clauses pertaining to a bond paid for by the firm which the agent must obtain to guarantee that the agent performs under the terms of the contract and holding harmless the firm from any claims made by a firm client for failure of the agent in making the agreed rebate. There may also be clauses relating to payment by the agent to the firm of an annual registration fee and updating of database information. A determination is made in decision block 502 as to whether the agent accepts the contract. If not, the process exits at block 504. If the agent accepts the contract, the agent then applies for the required bond in function block 506. A determination is made in decision block 508 as to whether the bond is issued to the agent. If not, the process exits at block 504. If, however, the bond is issued to the agent, the agent is issued an identification number and the agent and the agent's information are added to the firm's database in function block 510. At this time, any additional information, including for example a photograph of the agent, may be requested to complete the information desirable for the firm's database. At this point, the process exits at block 504.

Turning now to FIG. 6, the process shown here is the subroutine of block 204 in FIG. 2. This is the process of matching an agent from the firm's database with a firm client for purposes of listing a property for sale and for purchasing a property. The subroutine is entered at block 600 and a determination is first made in decision block 602 whether the client is initially a seller or a buyer. If a seller, the seller agent database is accessed in function block 604, but if a buyer, the buyer agent database is accessed in function block 606. Using the client information, the client is matched with an agent by location and market in function block 608. Other factors, including language skills and other special skills of the agent, may be considered in matching the client to an agent in the firm's database. Once a match is made, the agent is contacted and provided with the client referral information in function block 610. The agent has the option of accepting or not the client referred to him or her by the firm. A determination is made in decision block 612 as to whether the agent accepts the referral. If not, the process loops back to decision block 602 where, once again, the appropriate agent database is accessed, but this time the refusing agent is not considered. Assuming the agent accepts the referral, as determined in decision block 612, a return is made at 614 to function block 206 in FIG. 2.

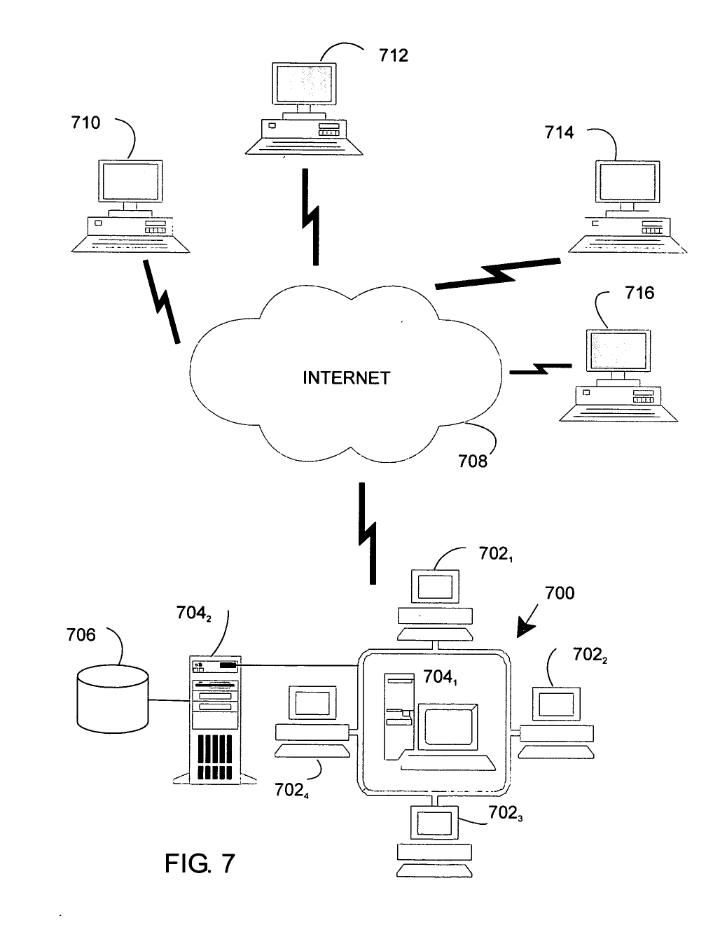

The processes described are in part computer aided. FIG. 7 illustrates a generalized network on which these processes may be implemented. The “fee-for-services” firm maintains a local area network (LAN) 700 to which are attached a plurality of client computers 702₁, 702₂, 702₃, and 702₄, and one or more servers 704₁ and 704₂. One of these servers 704₂ is connected to a database 706 which maintains a client database and an agent database. Access to the firm's LAN 700 is by operators of the several client computers 702₁, 702₂, 702₃, and 702₄ who may receive telephone calls from potential customers and agents to enter information into the client and agent databases. Access may also be via the Internet 708. In this case, potential customers using their respective computers 710 and 712 may access the firm's Web site to perform the registration process described above. Likewise, agents using their respective computers 714 and 716 may access the firm's Web site to perform the registration process, also described above.

From the foregoing description, it will be appreciated that the invention achieves several important advantages to the several participants in the transaction. The seller realizes a reduced commission as a result of the rebate from the listing agent. The listing agent increases his or her number of listings without having to do the work that ordinarily would be involved in obtaining those listings. A purchaser receives commission rebate when buying a property. The selling agent increases his or her sales by receiving referrals of serious buyers. The transaction service firm attracts potential sellers and buyers, and their fees, without having to offer traditional brokerage services, such as advertising and holding open houses. And all of this achieved with no direct negative financial impact on the brokerage firms, as they continue to collect the full amount of their fees, as in a normal transaction.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer implemented method for real estate transactions, comprising the steps of:
registering with a transaction service, using a computer, a plurality of customers and entering registered customers in a transaction service database, each with one or more properties owned by the customer and which are to be sold and/or seeking to purchase one or more properties, said transaction service providing a guarantee to each registered customer of a rebate of a portion of a listing and/or selling agent's commission upon the sale or purchase of property,
registering with said transaction service, using a computer, a plurality of licensed agents and entering registered agents in a transaction service database, registered licensed agents providing to the transaction service a guarantee that they will provide a rebate of a listing or selling agent's commission upon the sale of a property, said property being referred to the agent by the transaction service for listing or selling, and
matching, using a computer and accessing the transaction service's databases, each of said plurality of registered customers to at least one of said registered licensed agents, and providing by the transaction service a referral to said at least one of said registered licensed agents for listing or selling a customer's property.

2. The computer implemented method for real estate transactions recited in claim 1, wherein the step of registering customers comprises the steps of:
obtaining customer information including whether the customer is a seller or a buyer,
obtaining payment or credit approval for registration of a customer, and
entering into a contractual arrangement between the transaction service and each of the plurality of customers, wherein the contractual arrangement provides a guarantee of a rebate of a portion of a listing or selling agent's commission upon sale of the property.

3. The computer implemented method for real estate transactions recited in claim 2, wherein the step of registering customers is performed on-line.

4. The computer implemented method for real estate transactions recited in claim 1, wherein the step registering licensed agents comprises the steps of:
obtaining agent identification including licensing jurisdiction(s), brokerage firm, and level of experience,
obtaining payment or credit approval for registration of an agent, and
entering into a contractual arrangement between the transaction service and each of the plurality of agents, wherein the contractual arrangement provides a guarantee by the agent that the agent will provide a rebate of a portion the listing or selling commission upon sale of a property.

5. The computer implemented method for real estate transactions recited in claim 4, wherein the step of registering licensed agents is performed on-line.

6. The computer implemented method for real estate transactions recited in claim 1, wherein said step of matching comprises the steps of:
identifying a registered agent from the transaction service's databases who qualifies to list or sell a registered customer's property,
referring to a registered agent the registered customer seeking to sell or buy property as determined in said step of identifying,
determining whether the registered agent accepts a referral from the transaction service and, if not, repeating said steps of identifying and referring until an agent accepts the referral,
determining whether the registered customer accepts an agent to whom a referral has been made and, if not, repeating said steps of identifying, referring and determining until the registered customer accepts an agent, and
confirming that an agent accepted by a customer has entered into a rebate agreement with the customer.

7. The computer implemented method for real estate transactions recited in claim 1, wherein the step of registering customers comprises the steps of:
obtaining customer information including whether the customer is a seller or a buyer,
obtaining payment or credit approval for registration of a customer, and
entering into a contractual arrangement between the transaction service and each of the plurality of customers, wherein the contractual arrangement provides a guarantee of a rebate of a portion of a listing or selling agent's commission upon sale of the property,
and wherein the step of registering licensed agents comprises the step of:
obtaining agent identification including licensing jurisdiction(s), brokerage firm, and level of experience,
obtaining payment or credit approval for registration of an agent, and
entering into a contractual arrangement between the transaction service and each of the plurality of agents, wherein the contractual arrangement provides a guarantee by the agent that the agent will provide a rebate of a portion the listing or selling commission upon sale of a property,
and wherein the step of matching comprises the steps of:
identifying a registered agent from the transaction service's databases who qualifies to list or sell a registered customer's property,
referring to a registered agent the registered customer seeking to sell or buy property as determined in said step of identifying,
determining whether the registered agent accepts a referral from the transaction service and, if not, repeating said steps of identifying and referring until an agent accepts the referral,
determining whether the registered customer accepts an agent to whom a referral has been made and, if not, repeating said steps of identifying, referring and determining until the registered customer accepts an agent, and
confirming that an agent accepted by a customer has entered into a rebate agreement with the customer.

8. The computer implemented method for real estate transactions recited in claim 7, wherein the steps of registering customers and licensed agents are performed on-line.

9. A computer system for real estate transactions comprising:
a transaction service computer used for registering a plurality of customers and a plurality of licensed agents; and
a transaction service database for entering and storing registered customers and registered licensed agents, each of said registered customers entered into the transaction service database with one or more properties owned by the customer and which are to be sold and/or seeking to purchase one or more properties, said transaction service providing a guarantee to each registered customer of a rebate of a portion of a listing and/or selling agent's commission upon the sale or purchase of property, each of said registered licensed agents entered into the transaction service database providing to the transaction service a guarantee that they will provide a rebate of a listing or selling agent's commission upon the sale of a property, said property being referred to the agent by the transaction service for listing or selling;
said transaction service computer accessing said transcation service database and matching each of said plurality of registered customers to at least one of said registered licensed agents, and providing a referral to said at least one of said registered licensed agents for listing or selling a customer's property.

10. The computer system for real estate transactions recited in claim 9, further comprising:
a network to which the transaction service computer is attached;
one or more customer computers connected to the network and communicating with the transaction service computer to register customers with the transaction service; and
one or more licensed agent computers connected to the network and communicating with the transaction service computer to register licensed agents with the transaction service.

11. The computer system for real estate transactions recited in claim 9, wherein the transaction service computer is part of a local area network including one or more client computers and one or more server computers.

12. The computer system for real estate transactions recited in claim 9, wherein the network is the Internet.

13. A computer readable medium containing computer readable code for real estate transactions, said computer readable code implementing the method comprising the steps of:
registering with a transaction service, using a computer, a plurality of customers and entering registered customers in a transaction service database, each with one or more properties owned by the customer and which are to be sold and/or seeking to purchase one or more properties, said transaction service providing a guarantee to each registered customer of a rebate of a portion of a listing and/or selling agent's commission upon the sale or purchase of property,
registering with said transaction service, using a computer, a plurality of licensed agents and entering registered agents in a transaction service database, registered licensed agents providing to the transaction service a guarantee that they will provide a rebate of a listing or selling agent's commission upon the sale of a property, said property being referred to the agent by the transaction service for listing or selling, and
matching, using a computer and accessing the transaction service's databases, each of said plurality of registered customers to at least one of said registered licensed agents, and providing by the transaction service a referral to said at least one of said registered licensed agents for listing or selling a customer's property.

14. The computer readable medium containing computer readable code for real estate transactions recited in claim 13, wherein the step of registering customers comprises the steps of:
obtaining customer information including whether the customer is a seller or a buyer,
obtaining payment or credit approval for registration of a customer, and
entering into a contractual arrangement between the transaction service and each of the plurality of customers, wherein the contractual arrangement provides a guarantee of a rebate of a portion of a listing or selling agent's commission upon sale of the property.

15. The computer readable medium containing computer readable code for real estate transactions recited in claim 13, wherein the step registering licensed agents comprises the steps of:
obtaining agent identification including licensing jurisdiction(s), brokerage firm, and level of experience,
obtaining payment or credit approval for registration of an agent, and
entering into a contractual arrangement between the transaction service and each of the plurality of agents, wherein the contractual arrangement provides a guarantee by the agent that the agent will provide a rebate of a portion the listing or selling commission upon sale of a property.

16. The computer readable medium containing computer readable code for real estate transactions recited in claim 13, wherein said step of matching comprises the steps of:
identifying a registered agent from the transaction service's databases who qualifies to list or sell a registered customer's property,
referring to a registered agent the registered customer seeking to sell or buy property as determined in said step of identifying,
determining whether the registered agent accepts a referral from the transaction service and, if not, repeating said steps of identifying and referring until an agent accepts the referral,
determining whether the registered customer accepts an agent to whom a referral has been made and, if not, repeating said steps of identifying, referring and determining until the registered customer accepts an agent, and
confirming that an agent accepted by a customer has entered into a rebate agreement with the customer.

17. The computer readable medium containing computer readable code for real estate transactions recited in claim 13, wherein the step of registering customers comprises the steps of:
obtaining customer information including whether the customer is a seller or a buyer,
obtaining payment or credit approval for registration of a customer, and
entering into a contractual arrangement between the transaction service and each of the plurality of customers, wherein the contractual arrangement provides a guarantee of a rebate of a portion of a listing or selling agent's commission upon sale of the property,
and wherein the step of registering licensed agents comprises the step of:
obtaining agent identification including licensing jurisdiction(s), brokerage firm, and level of experience,
obtaining payment or credit approval for registration of an agent, and
entering into a contractual arrangement between the transaction service and each of the plurality of agents, wherein the contractual arrangement provides a guarantee by the agent that the agent will provide a rebate of a portion the listing or selling commission upon sale of a property,
and wherein the step of matching comprises the steps of:
identifying a registered agent from the transaction service's databases who qualifies to list or sell a registered customer's property,
referring to a registered agent the registered customer seeking to sell or buy property as determined in said step of identifying,
determining whether the registered agent accepts a referral from the transaction service and, if not, repeating said steps of identifying and referring until an agent accepts the referral,
determining whether the registered customer accepts an agent to whom a referral has been made and, if not, repeating said steps of identifying, referring and determining until the registered customer accepts an agent, and
confirming that an agent accepted by a customer has entered into a rebate agreement with the customer.
